(19) United States
(12) Patent Application Publication
(10) Pub. No.: US 2012/0131777 A1
(43) Pub. Date: May 31, 2012

(54) Golf club shaft extractor

(76) Inventor: Barry Lyn Holtzman, Eagle River, WI (US)

(21) Appl. No.: 12/928,009

(22) Filed: Nov. 30, 2010

(51) Int. Cl. B25B 27/14; B23P 19/04

(52) U.S. Cl. 29/239; 29/264

(57) ABSTRACT

An embodiment of this golf club shaft extractor has a slotted externally threaded member and an internally threaded member. The externally threaded member, using its slot, is placed on the shaft, and the internally threaded member is placed on the shaft over the shaft's grip, and these members are then joined by their threads. A vise then clamps the shaft such that the club head's hosel touches and centers in a tapered cavity in the externally threaded member, and the internally threaded member touches the vise. After the hosel is heated to weaken the shaft's adhesive bond, while preventing rotation of the externally threaded member, the internally threaded member is rotated in a direction which reduces the thread engagement distance, thereby increasing the overall length of the joined members and pushing the head away from the shaft. This extractor is relatively low in cost, using items commonly possessed by club fitters to reduce the number of additional parts required. A relatively wide slot in the externally threaded member allows this extractor to be used on a wide range of shaft tip diameters, and the tapered cavity provides self-centering of the extractor even on shaft diameters at the smaller end of the range.

### CROSS REFERENCE TO RELATED APPLICATIONS

Not Applicable

### FEDERALLY SPONSORED RESEARCH OR DEVELOPMENT

Not Applicable

### SEQUENCE LISTING, TABLE, OR PROGRAM

Not Applicable

### BACKGROUND

1. Field

This application relates to extractors used to pull a golf club shaft out of a golf club head.

2. Prior Art

Golf clubs have three main components: a shaft, a club head attached to the shaft's tip end, and a grip covering the shaft's butt end. Shafts are typically adhesively secured in a hole in a tubular extension of the head called a hosel. Sometimes it is necessary to extract a golf shaft from its head because the shaft has been damaged or because a golfer would like to try a different shaft in a head. Some desirable features of a golf shaft extractor and an extraction procedure are listed here.

Since the shaft's tip end is relatively small in diameter and easily damaged by an applied torque, a desirable feature of an extractor is that, during extraction, the extractor does not apply a torque to the shaft. Since the shaft and hosel are adhesively bonded (extraction normally involves heating to weaken the bond, but the bond is not eliminated), it is necessary that the extractor not apply a torque to the hosel in order to not apply a torque to the shaft. Since the extractor pushes on the hosel, friction between the hosel and the part of the extractor which touches the hosel can transmit a torque from the extractor to the hosel and hence the shaft. Therefore, a desirable feature is that the extractor can function in a manner which does not apply a torque to the hosel.

Another desirable feature is that no cosmetic or mechanical damage is done to the shaft by the extractor. Improper clamping, excessive heating, or misalignment between the extractor and shaft can cause shaft damage during extraction.

Another desirable feature is that the extractor can be used on a shaft which has a grip installed. A grip is normally cut when removed and is therefore ruined. If a golfer extracts a shaft but later wants to use the shaft again, if the grip was removed to do the extraction, then a new grip must be installed on the shaft, requiring extra time and expense.

Another desirable feature is that the extractor uses tools and components many club fitters already have, thereby reducing the number of special parts needed to perform the extraction.

Another desirable feature is that the extractor can be used with golf clubs having different shaft tip and hosel diameters without requiring different component parts for these different diameters. It is furthermore desirable that this “one size fits all” extractor still be somewhat self-centering and self-aligning with shafts and hosels of various diameters to prevent shaft damage and provide smooth operation of the extractor.

Extractors or pullers that are not described as being specifically used for extracting golf club shafts have been invented which do not possess some of the desirable features described above. One invention is shown in U.S. Pat. No. 1,631,889 to Rappley, but the method shown to clamp the puller to the shaft would cause damage to the shaft, especially a graphite shaft. Also, since the female threaded member of the puller is shown clamped to the shaft, the male member must be rotated relative to the shaft, and since the male member would touch the hose', it would apply a torque to the hosel and hence the shaft. Also, as shown, the puller could not be used on a shaft that has a grip installed. U.S. Pat. No. 3,858,300 to Borel shows a jackscrew which uses toothed jaws to hold a shaft; these jaws could cause cosmetic and mechanical damage to a golf shaft. Also, since the member having male threads would be secured to the golf club's shaft, the member having female threads must be rotated relative to the shaft, and since this member would touch the hosel, it would apply a torque to the hosel and hence the shaft.

There are several extractors described as being specifically used for golf clubs which do not possess some of these desirable features. U.S. Pat. No. 2,160,395 to Wettlaufer shows an extractor which does not efficiently use tools commonly possessed by club fitters such as a vise, hence, it has a relatively large number of special parts. Also, a male threaded member is shown clamped to the shaft, and a nut is rotated to do the extraction. A split washer is placed between the hosel and the nut, but rotation of the nut will still apply a torque to the hosel and shaft due to frictional forces on both sides of the washer. The extractor shown in U.S. Pat. No. 4,910,849 to Marshall requires the user to drill a hole through the golf shaft so the shaft can be pinned to the extractor; this hole damages the shaft. Also, when the nut is tightened to compress the spring, a torque will be applied to the shaft through the pin. Also, this extractor as shown could not be positioned on a shaft with a grip installed. U.S. Pat. No. 5,587,464 to Marshall describes an extractor which has several unnecessary parts because it does not effectively use tools commonly possessed by club fitters such as a vise. Also, rotation or the push member or nut used to compress the spring will exert a torque on the shaft. U.S. Pat. No. 7,000,299 to Samchisen shows an extractor which has a slotted member with two sets of male threads, two slotted nuts, and a special wrench. Several of these components and features are not necessary in the extractor of the present invention, and this extractor as described would not be optimally useful on shafts and hosels of different diameters.

Several extractors are commercially available today which contain multiple component parts with a similar function in order that these extractors can be used on shafts and hosels of different diameters. None of these extractors, nor any of the patents referenced above, show a golf club shaft extractor which can be used on shafts and hosels of different diameters, which does not contain special parts for these various diameters, and which urges the extractor to self-center and self-align with shafts and hosels having a relatively wide range of diameters.

### SUMMARY

In accordance with one embodiment, a golf club shaft extractor comprises a slotted externally threaded member joined by its threads to an internally threaded member. A vise clamps the shaft such that a tapered cavity in the externally threaded member touches the head's hosel, thereby centering and aligning the joined members with the shaft, and the internally threaded member touches the vise. After the hosel is heated to weaken the shaft's adhesive bond, while preventing rotation of the externally threaded member, the internally threaded member is rotated in a direction which reduces the engagement length of the threads, thereby pushing the head away from the shaft.

### DRAWINGS-BRIEF DESCRIPTION

FIG. 1 shows in perspective the relative positions of a golf club and components used in this golf shaft extractor, namely a vise, an internally threaded member, and an externally threaded member assembly.

FIG. 2 shows in cross-section details of the externally threaded member, and

FIG. 3 shows an end view of this member.

FIGS. 4 and 5 show in perspective an initial position of the extractor components in preparation for shaft extraction and a later position after extraction has progressed.

DRAWINGS - REFERENCE NUMERALS

| | |
|---|---|
| 1 | golf club head |
| 4 | golf club shaft |
| 5 | golf club grip |
| 6 | club head hosel |
| 7 | vise |
| 8 | clamping cushion |
| 10 | externally threaded member |
| 11 | external threads |
| 12 | heat shield |
| 13 | wrench flats |
| 14 | reduced diameter portion |
| 16 | tapered cavity |
| 18 | slot |
| 20 | internally threaded member assembly |
| 21 | nut |
| 22 | internal threads |
| 24 | torque arm |

### DETAILED DESCRIPTION OF AN EMBODIMENT OF THE INVENTION

### FIG. 1

FIG. 1 shows an embodiment of this golf club shaft extractor, the golf club having a head 1, a shaft 4, and a grip 5. Head 1 has a tubular-shaped extension, hosel 6, which contains a hole into which shaft 4 is secured using a suitable adhesive, usually an epoxy. A vise 7 is used to clamp shaft 4 between its jaws, using a rubber clamping cushion 8 to prevent vise 7 from damaging shaft 4. Most club fitters already have vise 7 and clamping cushion 8 as these items are normally used when shaft 4 is re-gripped, a common maintenance procedure for golf clubs. Note that vise 7 is not closed sufficiently in this figure to effectively clamp shaft 4.

An externally threaded member 10 has a relatively large diameter portion, shown at the right end of member 10, onto which external threads 11 have been machined. Typically, the main body of member 10 would be machined on a lathe, so member 10 would have an axis, threads 11 would have an axis, and these axes would be essentially co-linear. On the other end of member 10 is another relatively large diameter portion which is a heat shield 12. A gas torch or electric heat gun is normally used to heat hosel 6 to weaken the epoxy bond, and the relatively large diameter of heat shield 12 helps reduce convective heat transfer past shield 12. Two wrench flats 13 are machined onto heat shield 12; a wrench (not shown) can be applied to these flats 13 to apply a torque to member 10. A small diameter portion 14, located centrally in member 10, reduces heat flow through member 10 thereby reducing unwanted heating of shaft 4. Also, a tapered cavity 16 is machined in member 10 into which hosel 6 will be placed. A slot 18 is milled through external threads 11 and further into member 10, the depth of slot 18 being sufficient to allow member 10 to be placed on shaft 4 so their axes are approximately co-linear.

An internally threaded member assembly 20 is shown located between externally threaded member 10 and vise 7. Assembly 20 contains a nut 21 with internal threads 22 and an optional torque arm 24 which can be used to apply torque to nut 21. It is preferable that internal threads 22 have a minor diameter sufficiently large to allow grip 5 to pass through them, thus allowing assembly 20 to be placed on shaft 4 with grip 5 applied. A commercially available nut 21 with internal threads 22 of Unified American thread size 1¼-12 has a sufficiently large internal thread minor diameter that most grips 5 will pass through nut 21.

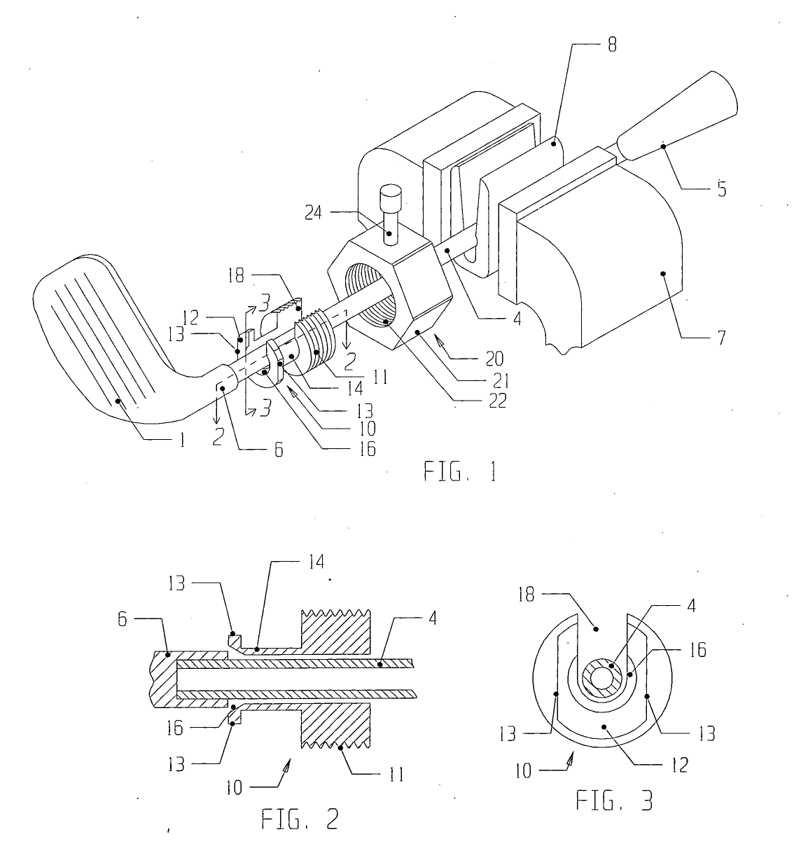

### FIG. 2

FIG. 2 shows a cross-sectional view taken through the approximately co-linear axes of member 10, external threads 11, and shaft 4. This figure shows the tip end of shaft 4 located in the hole in hosel 6, normally secured with an epoxy adhesive (not shown). Since the body of member 10 is normally turned on a lathe, the straight sides of cavity 16 shown in this figure will, in three dimensions, define a truncated cone, a frustum of a cone (ignoring slot 18).

This figure shows that the contact area between hosel 6 and cavity 16 is less than that which would exist if the end of member 10 did not have cavity 16. If member 10 had a flat end (absent cavity 16), the contact area between member 10 and hosel 6 would approximately equal the area of the annular surface defined by the outside diameter of shaft 4 and the outside diameter of hosel 6. Providing cavity 16, however, depending on the exact shape of the end of hosel 6, makes this contact between hosel 6 and cavity 16, ignoring slot 18, a somewhat “fuzzy circle”, approximately a frustum of a cone with a relatively small height and hence a relatively small area. This small contact area reduces heat flow from hosel 6 into member 10, thereby providing improved efficiency of hosel 6 heating and a beneficial reduction in heat flow to member 10 and shaft 4.

This figure also shows more clearly how tapered (in this case conical) cavity 16 allows member 10 to be used with hosels 6 having different diameters. The hosel 6 shown in this figure will contact cavity 16 at a first location along the axis of member 10. It can be seen, however, that if hosel 6 had a smaller diameter than shown, it would contact cavity 16 at a second location more to the right of the first location, deeper into cavity 16. The converse would hold if hosel 6 had a larger diameter than shown. Thus, hosels 6 having a range of outside diameters will contact cavity 16 satisfactorily: contact will just occur at different positions along the axis of member 10.

A force pushing member 10 against hosel 6 will tend to make the axis of hosel 6 and shaft 4 parallel with the axis of member 10, whether member 10 has tapered cavity 16 or if it just has a flat end. But if tapered cavity 16 is provided, the taper of cavity 16, as a result of this force, will also tend to make hosel 6 self-center in cavity 16, therefore tending to make the axis of shaft 4 and the axis of member 10 not only parallel, but additionally co-linear. This tendency of these axes to be not only parallel, but also co-linear, provided by tapered cavity 16, helps provide smooth extractor operation and helps prevent damage to shaft 4 during extraction.

Of course, other tapers for cavity 16 will work to attain these benefits. FIG. 2 shows straight sides for cavity 16 resulting in a conical shape, but curved sides could also be used successfully. The important consideration is that the diameter of cavity 16 gets smaller as the distance into cavity 16 gets larger. This principle will accomplish the above benefits of self-centering, self-aligning, and heat flow reduction. It has been found that a taper having straight sides with an included angle of 82 degrees works well.

### FIG. 3

FIG. 3, an end view of member 10, shows more clearly wrench flats 13 and slot 18. Slot 18 has sufficient depth so that shaft 4 can be positioned so the center of shaft 4 is located approximately on the axis of member 10, shaft 4 being urged there by cavity 16 acting on hosel 6, discussed above. Slot 18 can typically be provided in member 10 by first drilling an axial hole through member 10 which has a diameter approximately equal to the width of slot 18, then completing slot 18 by milling a side of member 10 to the center of this hole.

Golf shafts 4 come with tip ends having various diameters, the most common being 0.335 inches (8.5 mm), 0.350 inches (8.9 mm), and 0.370 inches (9.4 mm), but there are a few with tip diameters of about 0.428 inches (10.9 mm). A slot 18 having a width of 0.437 inches (11.1 mm) will allow member 10 to be placed on a shaft 4 having any of these diameters, even the largest 0.428 inch diameter. If a shaft 4 having a diameter of 0.335 inches is placed in this slot 18 having a width of 0.437 inches, the axis of shaft 4 and the axis of member 10 may differ considerably, in both relative location and direction. But when hosel 6 is subsequently pushed against tapered cavity 16, as discussed above, cavity 16 will tend to force hosel 6 to center on and align with member 10, thereby tending to make the axis of shaft 4 co-linear with the axis of member 10. Thus, tapered cavity 16 provides self-centering and self-aligning of member 10 with shaft 4, even when the diameter of shaft 4 is considerably less than the width of slot 18. Therefore, it can be seen that this embodiment, having a relatively wide slot 18 and tapered cavity 16, provides an extractor which can be placed on a shaft 4 which has a relatively large tip diameter but which will still tend to center on and align with shaft 4 to make the axis of member 10 and shaft 4 approximately co-linear.

### Operation

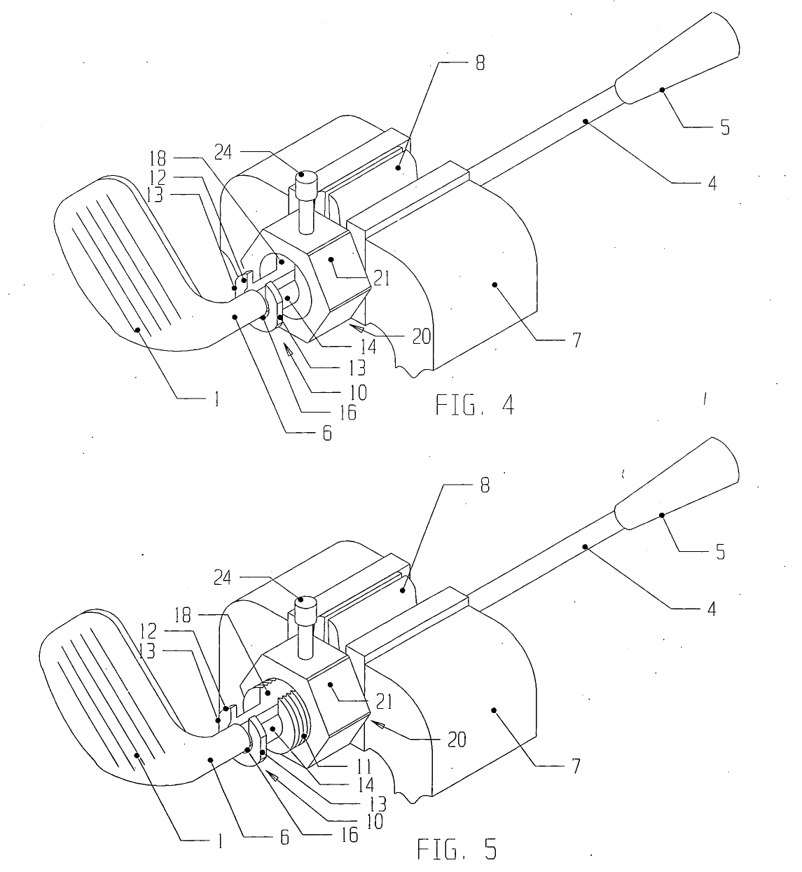

### FIGS. 4 AND 5

FIGS. 4 and 5 show, in perspective, how member 10 and assembly 20 are used to perform the extraction. In FIG. 1, member 10, assembly 20, hosel 6, and vise 7 are all spaced apart, and vise 7 is shown in a relatively open position so shaft 4 is not effectively clamped. To get from the spaced positioning shown in FIG. 1 to the tight positioning shown in FIG. 4, member 10 is joined by its threads 11 to assembly 20 by screwing member 10 into nut 21 with a relatively large thread engagement distance, shaft 4 is moved in vise 7 so that cavity 16 contacts hosel 6 and nut 21 contacts vise 7, and finally vise 7 is closed to securely clamp shaft 4. After the components are in the position shown in FIG. 4, heat is applied to hosel 6 to weaken the epoxy bond holding shaft 4 in hosel 6.

FIG. 5 shows the position of the components after the extraction procedure has progressed, subsequent to hosel 6 heating, so that shaft 4 has been partially withdrawn from hosel 6 of head 1. This FIG. 5 position results from rotation of nut 21 using optional torque arm 24 while rotation of member 10 is prevented using a wrench (not shown) applied to flats 13. The wrench is used to apply sufficient torque to member 10, in opposition to the torque applied to nut 21, to prevent member 10 rotation and to prevent member 10 from applying a torque to hosel 6 and hence shaft 4. Nut 21 is rotated relative to member 10 so that the thread engagement distance of external threads 11 with internal threads 22 is reduced, thereby increasing the overall length of joined member 10 and assembly 20, thus applying a force to push head 1 away from vise 7. Since shaft 4 is securely clamped in vise 7, head 1 is moved in a direction away from shaft 4, thus breaking the epoxy bond between hosel 6 and shaft 4 so head 1 can be removed from shaft 4.

### CONCLUSION, RAMIFICATIONS, AND SCOPE

Accordingly, the reader will see that an embodiment of this golf club shaft extractor has a slotted externally threaded member and an internally threaded member. The externally threaded member, using its slot, is placed on the shaft, and the internally threaded member is placed on the shaft over the shaft's grip, and these members are then joined by their threads. A vise then clamps the shaft such that the club head's hosel touches and centers in a tapered cavity in the externally threaded member, and the internally threaded member touches the vise. After the hosel is heated to weaken the shaft's adhesive bond, while preventing rotation of the externally threaded member, the internally threaded member is rotated in a direction which reduces the thread engagement distance, thereby increasing the overall length of the joined members and pushing the head away from the shaft. This extractor is relatively low in cost, using items commonly possessed by club fitters to reduce the number of additional parts required. A relatively wide slot in the externally threaded member allows this extractor to be used on a wide range of shaft tip diameters, and the tapered cavity provides self-centering of the extractor even on shaft diameters at the smaller end of the range.

Although the description above contains many specificities, these should not be construed as limiting the scope of the invention but as merely providing illustrations of some embodiments of this invention. Thus, the scope of the invention should be determined by the appended claims and their legal equivalents, rather than by the examples given.

I claim:

1. An extraction apparatus used to pull a golf club shaft out of a golf club head, the apparatus comprising:
a first member having a hole with internal threads which is placed on the shaft by passing the shaft through the hole;
a second member having a portion with external threads and a slot through the external threads which is placed on the shaft by passing the shaft through the slot:
an assembly of the first member and the second member resulting from an engagement of the external threads with the internal threads, the engagement having a thread engagement distance;
a shaft clamping means which is clamped to restrict movement of the shaft;
and wherein the assembly is positioned relative to the golf club head and the shaft clamping means so that the first member has its movement restrained by the shaft clamping means and a reduction in the thread engagement distance causes the second member to apply a force to the head urging it to move away from the shaft clamping means;
whereby the head is moved away from the shaft.

2. An extraction apparatus of claim 1 wherein the shaft has a butt end with a grip applied and the first member is placed on the shaft by passing the butt end of the shaft with the grip applied through the hole in the first member.

3. An extraction apparatus of claim 1 wherein the first member contains a nut.

4. An extraction apparatus of claim 1 wherein the reduction in the thread engagement distance results from a rotation of the first member relative to the shaft while the second member is prevented from rotation relative to the shaft.

5. An extraction apparatus of claim 1 wherein the reduction in the thread engagement distance results from application to the first member of a first torque relative to the shaft and application to the second member of a second torque which is in an opposite direction to the first torque and has a magnitude whereby the resulting torque applied to the head is approximately zero.

6. An extraction apparatus of claim 1 wherein the shaft clamping means contains a vise.

7. An extraction apparatus of claim 1 wherein the shaft clamping means contains a vise and an elastomeric cushion between the shaft and the vise.

8. An extraction apparatus of claim 1 wherein;
a first golf club head has a first tubular shaped hosel having a first hosel outside diameter;
a second golf club head has a second tubular shaped hosel having a second hosel outside diameter:
the second member has an axis of its external threads;
the second member has a cavity which is tapered along the axis of the external threads;
and wherein the first tubular shaped hosel contacts the cavity at a first location along the axis and the second tubular shaped hosel contacts the cavity at a second location along the axis when the second member applies a force to the head.

9. An extraction apparatus of claim 8 wherein the shaft has an axis and wherein the tapered cavity urges the axis of the external threads to be co-linear with the axis of the shaft.

10. An extraction apparatus of claim 8 wherein the cavity absent the slot would define a frustum of a cone.

11. An extraction apparatus of claim 8 wherein contact between the tapered cavity and a cylinder having a first diameter would be an arc of a circle having approximately the first diameter and contact between the tapered cavity and a cylinder having a second larger diameter would be an arc of a circle having approximately the second diameter, and wherein the contact of the first cylinder with the tapered cavity would occur deeper in the cavity than the contact of the second cylinder with the tapered cavity.

12. An extraction apparatus of claim 1 wherein the external threads have an axis, the shaft has an axis, and the slot allows positioning so these two axes are approximately co-linear.

13. An extraction apparatus used to pull a golf club shaft out of a golf club head, the apparatus comprising:
a first member having a hole with internal threads and which is placed on the shaft by passing the shaft through the hole:
a second member having a portion with external threads, an axis of the external threads, and a cavity which is tapered along the axis of the external threads;
an assembly of the first member and the second member resulting from an engagement of the external threads with the internal threads, the engagement having a thread engagement distance;
a shaft clamping means which is clamped to restrict movement of the shaft;
and wherein the assembly is positioned relative to the golf club head and the shaft clamping means so that the first member has its movement restrained by the shaft clamping means, the head touches the second member in the tapered cavity, and a reduction in the thread engagement distance causes the second member to apply a force to the head urging it to move away from the shaft clamping means;
whereby the head is moved away from the shaft.

14. An extraction apparatus of claim 13 wherein the shaft has an axis and the tapered cavity in the second member urges the axis of the shaft to be approximately co-linear with the axis of the external threads when the second member applies the force to the head.

15. An extraction apparatus of claim 13 wherein a first head with a first hosel with a first outside diameter touches the tapered cavity at a first position and wherein a second head with a second hosel with a second larger outside diameter touches the tapered cavity at a second position.

16. An extraction apparatus of claim 15 wherein the first position is deeper into the cavity than the second position.

17. An extraction apparatus of claim 13 wherein the shaft has a butt end with a grip applied and the first member is placed on the shaft by passing the butt end of the shaft with the grip applied through the hole in the first member.

18. An extraction apparatus of claim 13 wherein the second member has a slot through the external threads and wherein the second member is placed on the shaft by passing the shaft through the slot.
